(19) United States
(12) Patent Application Publication
(10) Pub. No.: US 2012/0285588 A1
(43) Pub. Date: Nov. 15, 2012

(54) Padded Weather Protection Cover

(76) Inventor: James Sheppard, Llano, TX (US)

(21) Appl. No.: 13/107,738

(22) Filed: May 13, 2011

(51) Int. Cl. B60J 11/04

(52) U.S. Cl. 150/166

(57) ABSTRACT

A padded covering for vehicle may include a first covering member for covering the padded covering, a second covering member for covering the covering and a padded member being positioned between the first covering member and the second covering member for providing padding for the padded covering. The padded covering may include a transparent portion, and the transparent portion may correspond to the windshield of the vehicle. The transparent portion may correspond to the lights of the vehicle, and the transparent portion may maintain a spaced relationship with the windshield of the vehicle. The spaced relationship may be maintained with a suction cup, and the padded covering may include a slit. The slit may define a movable panel, and the padded covering may include a magnet to position the padded covering. The padded covering may include an aperture to position the padded covering, and the padded covering may extend over a hood of the vehicle.

### FIELD OF THE INVENTION

The present invention relates to covers, and more particularly to a cover for a vehicle which may be padded.

### BACKGROUND OF THE INVENTION

There are large areas of the United States and other parts of the world which may be affected by hail. At times, this hail can reach the size of large oranges which can cause significant damage to property and people alike. This type of hail may result in a large dent in a vehicle if the vehicle is caught outside during a hailstorm. The dents can quickly multiply and reach a number where it is uneconomical to repair the vehicle. Since these hailstorms may be unpredictable, it would be desirable to include sufficient protection from hail damage while in the vehicle. This would allow the owner of the vehicle sufficient time to deploy the protection as a hailstorm approaches.

### SUMMARY

A padded covering for vehicle may include a first covering member for covering the padded covering, a second covering member for covering the covering and a padded member being positioned between the first covering member and the second covering member for providing padding for the padded covering.

The padded covering may include a transparent portion, and the transparent portion may correspond to the windshield of the vehicle.

The transparent portion may correspond to the lights of the vehicle, and the transparent portion may maintain a spaced relationship with the windshield of the vehicle.

The spaced relationship may be maintained with a suction cup, and the padded covering may include a slit.

The slit may define a movable panel, and the padded covering may include a magnet to position the padded covering.

The padded covering may include an aperture to position the padded covering, and the padded covering may extend over a hood of the vehicle.

The padded covering may extend over a trunk of the vehicle, and the padded covering may extend over a cab of the vehicle without extending over the bed.

The padded covering may include a light for identification, and the padded covering may include a reflector for identification.

### BRIEF DESCRIPTION OF THE DRAWINGS

The invention may be understood by reference to the following description taken in conjunction with the accompanying drawings, in which, like reference numerals identify like elements, and in which:

FIG. 1 illustrates a side view of the padded covering for a vehicle of the present invention;

FIG. 2 illustrates a side view of the padded covering;

FIG. 3 illustrates a side view of the padded covering of the vehicle which may include a transparent portion;

FIG. 4 illustrates a side view of the padded covering which may include a second transparent portion;

FIG. 5 illustrates a side view of another padded covering of the present invention;

FIG. 6 illustrates a side view of the padded covering with the transparent portion;

FIG. 7 illustrates a side view of the padded covering with a second transparent portion;

FIG. 8 illustrates a front view of the padded covering of the present invention;

FIG. 9 illustrates a back view of the padded covering of the present invention;

FIG. 10 illustrates a side view of the padded covering of the present invention with a movable panel;

FIG. 11 illustrates a side view of the padded covering with an attachment member;

FIG. 12 illustrates a padded covering for an individual user;

FIG. 13 illustrates a top view of the padded cover;

FIG. 14 illustrates an identification member of the present invention

### DETAILED DESCRIPTION

The present invention provides protection for vehicles which may include automobiles, trucks and may include pickup trucks, all-terrain vehicles and any vehicle which has a significant outer surface which may be affected by hail. The protection may be in the form of a cover to provide for protection for vehicles equipment or personnel under storm conditions which may include hail, ice, snow, sleet and fair weather but may be used a significant amount of time for hail.

Since hailstorms can approach quickly, the present invention may include a cover which is designed for fast, easy application and removal. In essence, a portable garage is provided for the vehicle to be protected.

The cover of the present invention is designed to cushion the impact from hail which may be of any size. The cover of the present invention may reduce or eliminate the damage from hail and may result in no dents, no broken windshields and no paint damage on the vehicles or equipment. The cover of the present invention may be used by individuals to protect themselves during a hailstorm.

The cover of the present invention may be formed from a padded material and may include cotton, flannel, fleece, polyester, leather, Styrofoam, rubber, sponge foam, foam, felt, rubber, foam rubber, plastic, wood, Velcro which may include hooks and loops, water resistant material, cardboard, Styrofoam pellets, bio-degradable materials, Kevlar, webbing material, elastic, quilted waterproof material, bubble wrap, reflective material, erosion material, mildew resistant material, fishnet, forscent, magnetic material, porous and ribbed material, canvas, insulated material, porous breathable webbing material.

The protective cover may include magnetic strips or of various sized magnetic shapes which may be sewn inside seams. The protective cover may include eye hooks or grommets which may be used in cooperation with a bungee cord straps to secure the protective cover.

The protective cover may include an elastic skirt bottom in order to prevent the wind from blowing the protective cover away from the vehicle. The protective cover may include a tufted or quilted design which may include Styrofoam pellets or weatherproof material. Each quilted section may have a bean bag type design.

The protective cover may have a plexy-glass or have a clear plastic viewing area to cooperate with the windshield front and back or side in order to allow the users to view outside of the vehicle. The viewing area may include suction cups to attach the viewing area to the windshield and may provide a buffer to provide a space relationship with the windshield.

The protective cover may include zippers on the outside surface in order to allow the protective cover to be filled with material which may include weatherproof or non-weatherproof material.

The protective cover may include clear material which corresponds to the vehicle lights and flashers in order to provide for identification for other vehicles.

Alternatively, the protective cover may include no viewing areas.

The protective cover may include an outer layer which is waterproof or non-waterproof without the need for bungee strap hooks, skirted bottom or magnets.

Alternatively, the protective cover may include rubber or plastic suction cups to attach to the vehicle.

The outer surface of the protective cover may be a fluorescent color such as orange or yellow or other appropriate colors.

The outer surface of the protective cover may include reflective strips for greater visibility for other drivers.

The protective cover may include electrical flashing lights which may be sewn in or may be attached with Velcro (hooks and loops). The lights may run off batteries which may be included with the protective cover.

The protective cover may include gel or liquid material which may be located inside or outside to provide protective insulation.

The protective cover may include reflective silver material on the outside cover to reflect the rays of the sun.

The protective cover may be a disposable cover so that the protective cover can be disposed after one use.

The protective cover may include swivel hooks which may be coated or non-coated, buckles, Velcro, elastic, zippers, magnets, S hooks, bungee straps, rubber or plastic suction cups, or other appropriate devices in order to attach to bumpers, wheel wells, hubcaps or other appropriate available areas to hook the vehicle. The protective cover may include handles in order to move the protective cover.

The protective cover may be mildew resistance and may have a ribbed and porous design.

The protective cover may include a water resistant outside cover to protect the padding.

The protective cover may include a rubber or foam cushion sewn inside and may include waterproof plastic, canvas or other type of waterproof lightweight material.

The protective cover may be rolled up on a telescoping rod so that the rod can be collapsed once the protective cover has been rolled up. The telescoping rod may be spring-loaded for easy storage.

The outer cover of the protective cover may be a porous, breathable webbing and may include padding on the inside.

The protective cover may include eyes and hooks, but elastic, Velcro and zippers for exits.

The protective cover may include a storage bag for the protective cover, and the storage bag may be formed from water resistant material such as canvas. The storage bag may include a handle or may be without a handle.

FIG. 2 illustrates a padded covering 100 or protective cover which may include a first covering member 101 and an opposing second covering member 101 which may form a protective covering for padding member 103 which may be sandwiched between the first covering member 101 and the second covering member 101.

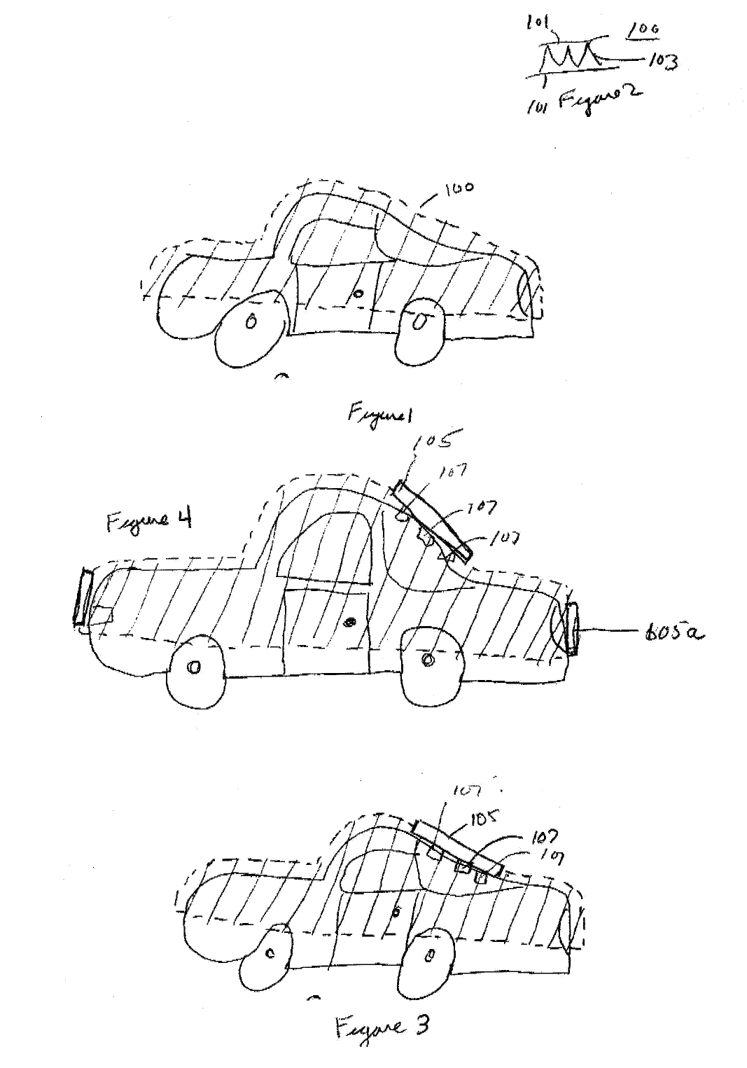

FIG. 1 illustrates the padded covering 100 which may be shaped to the general contours of a vehicle such as described above. The padded covering 100 may extend over the passengers compartment, the front of the car and the rear of the car and may extend substantially along the side of the car in order to provide protection against storm elements such as described above which may include hail. The padded covering 100 may be sized to cover different types of vehicles and may be shaped to conform to different types of vehicles.

FIG. 8 illustrates a front view of the vehicle and padded covering 100 and illustrates that the padded covering 100 extends over the hood and across the front of the vehicle. FIG. 8 additionally illustrates that the padded covering 100 extends over both sides of the vehicle and may extend near or touching the surface of the ground.

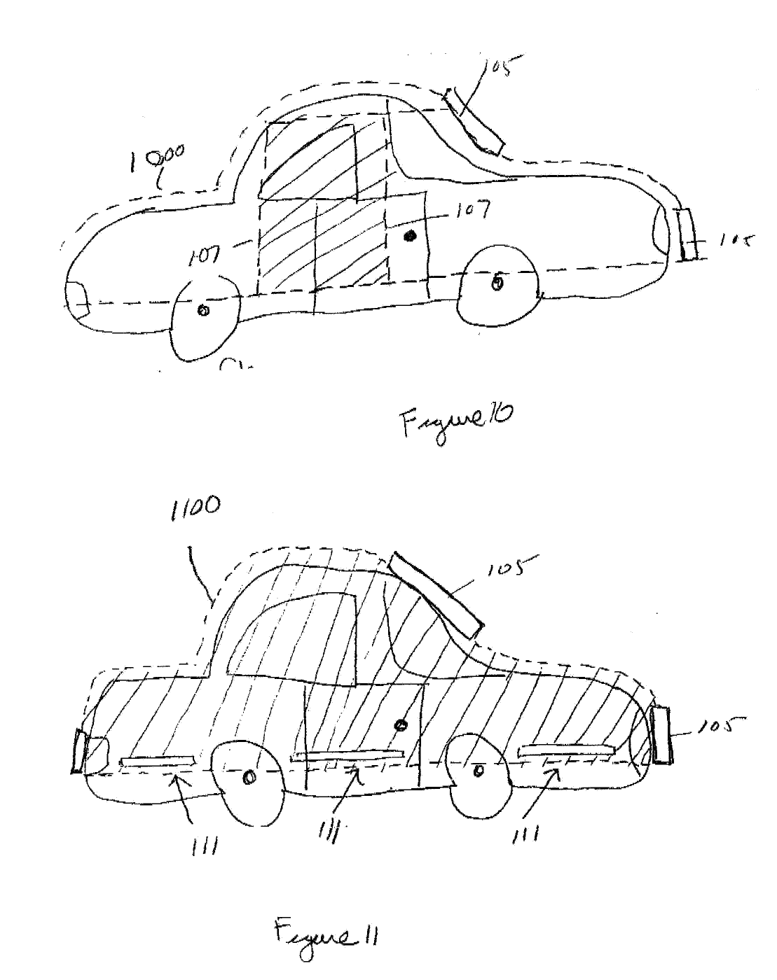

FIG. 9 illustrates a back view of the vehicle and padded covering 100 and illustrates that the padded covering 100 extends over the trunk and across the back of the vehicle.

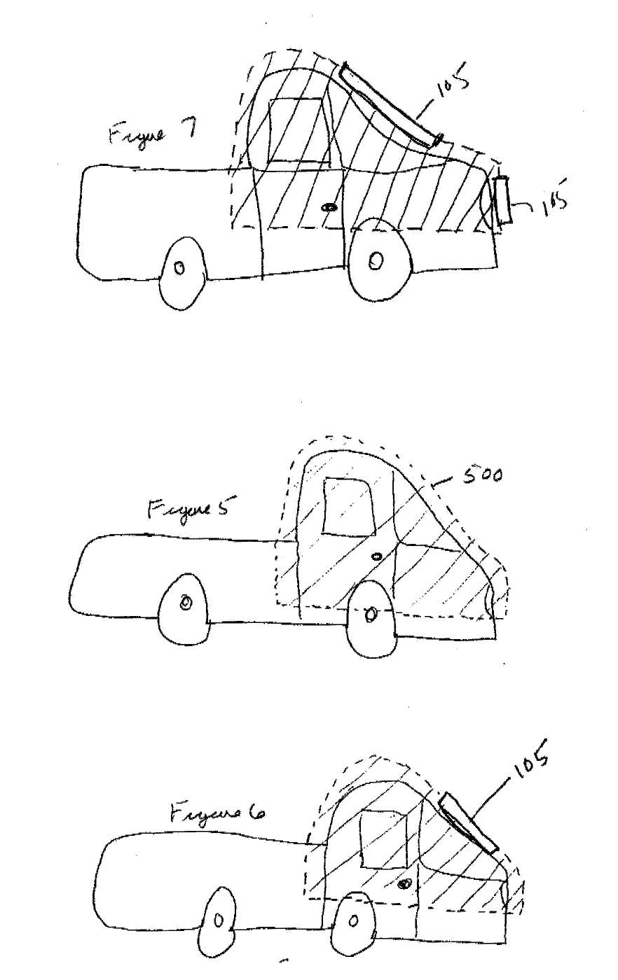

FIG. 3 illustrates that the padded covering 100 may include a portion of the padded covering 100 which may be a transparent portion 105 which may be positioned to cooperate with the windshield so that the users within the vehicle may see out. The transparent portion 105 may include spacers 107 which may be suction cups in order that the transparent portion 105 is in a space relationship with the vehicle including the windshield to ensure that there is no damage. The transparent portion 105 may be formed from plastic, glass or other suitable material.

FIG. 4 illustrates that the padded covering 100 includes a portion of the padding covering 100 which may be a second transparent portion 105a which may be positioned to cooperate with the lights of the vehicle so that the vehicle can be identified while it is parked under storm conditions.

FIG. 5 illustrates that the vehicle may be a pickup truck and illustrates that the padded covering 500 may substantially cover the cab and hood of the vehicle. FIG. 5 illustrates one side of the padded covering 500 may not extend over the bed vehicle for example a pickup truck.

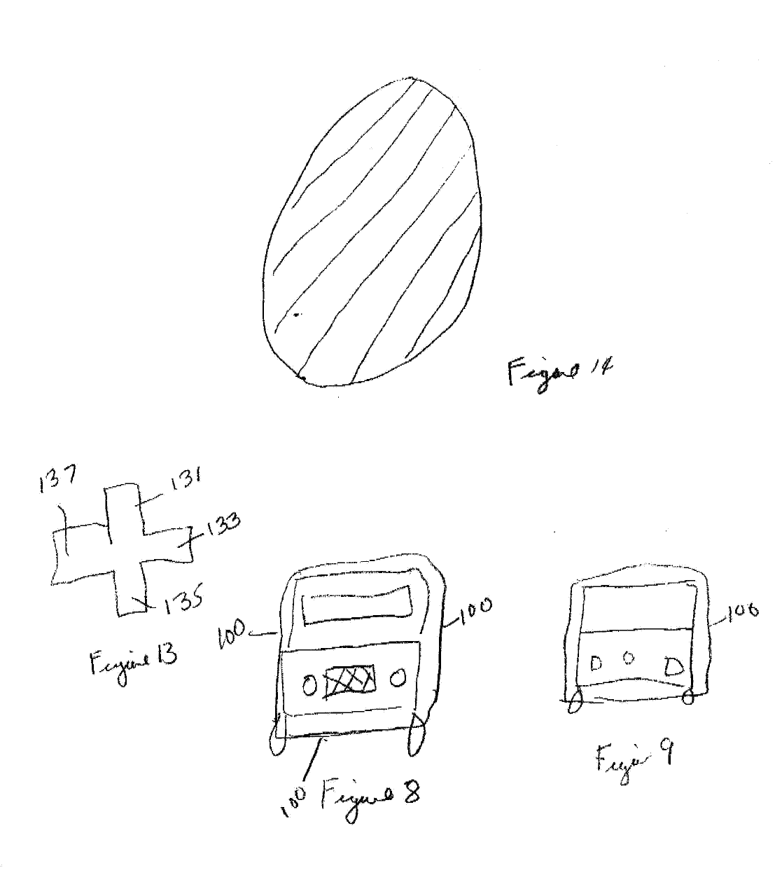

FIG. 6 illustrates that a transparent portion 105 may correspond to the windshield of the vehicle to allow the users of the vehicle to see outside of the vehicle. The transparent portion 105 may include a spacing device such as suction cups.

FIG. 7 illustrates that the first transparent portion 105 may correspond to the windshield of the vehicle and a second transparent portion 105 may correspond to the lights of the vehicle so that the vehicle can be identified to other users or drivers to avoid a collision.

FIG. 10 illustrates a padded covering 1000 which may include slits 107 to define a movable panel 109 which may cooperate with the door of the vehicle in order to allow the users of the vehicle to enter and exit the vehicle while the padded covering 1000 is in place.

FIG. 10 additionally illustrates that the padded covering 700 may include the transparent portion 105 which may correspond to windshield of the vehicle and may correspond to the lights of the vehicle.

FIG. 11 illustrates a padded covering 1100 which may include attachment members 111 which may be magnetic devices which may be sewn into the padded covering 1100. The attachment member 111 may be an aperture in the padded covering 1100 to allow a cord to pass through the aperture and retaining the padded covering 1100 in place. The attachment member 111 may be elastic which may urge the padded covering 1100 together underneath the vehicle and thus retain the padded covering in place.

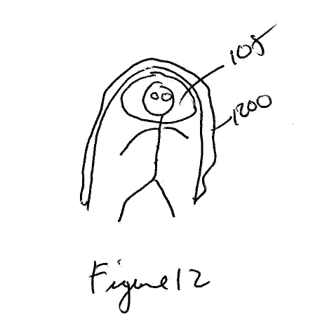

FIG. 12 illustrates a padded covering 1200 which may extend and may be shaped to fit directly over a user. The covering 1200 may include a transparent portion 105 which is positioned to cooperate with the eyes of the user so that the user can see.

FIG. 13 illustrates the general concept of the padded covering 1300. While FIG. 13 is not to scale, FIG. 13 illustrates the padded covering 1300 which may include a front portion 131 which may cover the windshield and hood of the vehicle, a back portion 135 which may cover the rear window and trunk of the vehicle, a first side portion 133 which may cover a side of the vehicle and a second side portion 137 which may cover another side of the vehicle.

FIG. 14 illustrates a identification member 1400 which may be attached to the protective cover as described in FIGS. 1-13, and the identification member 1400 may be a reflective device, a light (with or without batteries), a flashing device, or any other identification device. The identification member 1400 may operate from batteries or may be solar powered.

While the invention is susceptible to various modifications and alternative forms, specific embodiments thereof have been shown by way of example in the drawings and are herein described in detail. It should be understood, however, that the description herein of specific embodiments is not intended to limit the invention to the particular forms disclosed.

1. A padded covering for vehicle, comprising:
a first covering member for covering the padded covering;
a second covering member for covering the covering;
a padded member being positioned between the first covering member and the second covering member for providing padding for the padded covering.

2. A padded covering for vehicle as in claim 1, wherein the padded covering includes a transparent portion.

3. A padded covering for vehicle as in claim 2, wherein the transparent portion corresponds to the windshield of the vehicle.

4. A padded covering for vehicle as in claim 2, wherein the transparent portion corresponds to the lights of the vehicle.

5. A padded covering for vehicle as in claim 2, wherein the transparent portion maintains a spaced relationship with the windshield of the vehicle.

6. A padded covering for vehicle as in claim 5, wherein the spaced relationship is maintained with a suction cup.

7. A padded covering for vehicle as in claim 1, wherein the padded covering includes a slit.

8. A padded covering for vehicle as in claim 7, wherein the slit defines a movable panel.

9. A padded covering for vehicle as in claim 1, wherein the padded covering includes a magnet to position the padded covering.

10. A padded covering for vehicle as in claim 1, wherein the padded covering includes an aperture to position the padded covering.

11. A padded covering for vehicle as in claim 1, wherein the padded covering extends over a hood of the vehicle.

12. A padded covering for vehicle as in claim 11, wherein the padded covering extends over a trunk of the vehicle.

13. A padded covering for vehicle as in claim 11, wherein the padded covering extends over a cab of the vehicle without extending over the bed.

14. A padded covering for vehicle as in claim 1, wherein the padded covering includes a light for identification.

15. A padded covering for vehicle as in claim 1, wherein the padded covering includes a reflector for identification.
